(19) United States
(12) Patent Application Publication
(10) Pub. No.: US 2006/0012479 A1
(43) Pub. Date: Jan. 19, 2006

(54) Fuel dispensing system

(76) Inventor: Meir Ezra, Clearwater, FL (US)

Correspondence Address: VARNUM, RIDDERING, SCHMIDT & HOWLETT, LLP, P.O. BOX 352, GRAND RAPIDS, MI, 49501, US

(21) Appl. No.: 10/871,421

(22) Filed: Jun. 18, 2004

(51) Int. Cl. G06F 17/00

(52) U.S. Cl. 340/572.1; 705/16

(57) ABSTRACT

A wireless control system and process controls the dispensation of fuel from a fuel dispenser to a vehicle by detecting separate identification signals from the vehicle and from an article, such as a key, that is separable from the vehicle, and by preventing fuel dispensation unless a predetermined signal match is present. The control system controls fuel dispenser operation by means of a wireless control signal transmitted to a remotely controlled fuel nozzle control switch. The control system receives wireless electronic payment instructions from a customer input station and approves the payment instructions as well as verifies the identification signal by a wireless connection with a global information network that accesses information databases.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFISHE APPENDIX

Not applicable.

### BACKGROUND OF THE INVENTION

1. Field of the Invention

The present invention is in the field of fuel dispensing at the point of sale. The invention is also about a method of effecting payments in the point of sale. The invention provides a means to provide information relating to fuel consumption in vehicles in the framework of a fleet.

2. Background Art

In a fuel dispensing station referred to hereinafter as a point of sale (POS), fuel is dispensed to traveling vehicles stopping by. Apart from fuel, other commodities and articles of commerce may be offered for sale in such a POS. Some of these articles are strictly associated with motoring while others are not. At the POS, a forecourt typically harbors the dispensing units, a POS controller is located in a secluded room. Other shops or booths are typically present in the vicinity of the POS controller or the forecourt. In typical existing fuel dispensing stations, the dispensing units are connected by conducting wires to the POS, as described in FIG. 1 to which reference is now made. The dispensing units 30, 32, 34 and 36 are connected by respective cables 38, 40, 42 and 44 to the POS controller 46. The POS accepts money, money equivalents (e.g. vouchers), electronic money or credit card transactions. The POS controller 46 connects to the credit companies 48, such as a bank or the fuel company for confirming the transaction.

### BRIEF DESCRIPTION OF THE DRAWINGS

FIG. 1 is a schematic description of the connection between dispensing units and cashier in a fuel point of sale;

FIG. 2A is a schematic description of a first communications subsystem of the invention depicted as a bus;

FIG. 2B is a schematic description of a first communications subsystem of the invention depicted as LAN;

FIG. 2C is a schematic description of the entire communication system of the invention;

FIG. 3 is a schematic description of the cyclic activation schemes performed by the active vehicle tag;

FIG. 4A is a schematic description of a vehicle standing near a fuel dispenser employing three end points of the communication system of the POS of the invention;

FIG. 4B is a schematic description of a Nozzle transponder communicating with passive vehicle tag in a communications configuration of the invention;

FIG. 5A is a schematic description of a part of the communication system of the invention showing first and second subsystem interaction;

FIG. 5B is a schematic description of a part of the communication system of the invention showing second and third subsystem interaction; and

FIG. 6 is a chart describing the admissibility of payment cards.

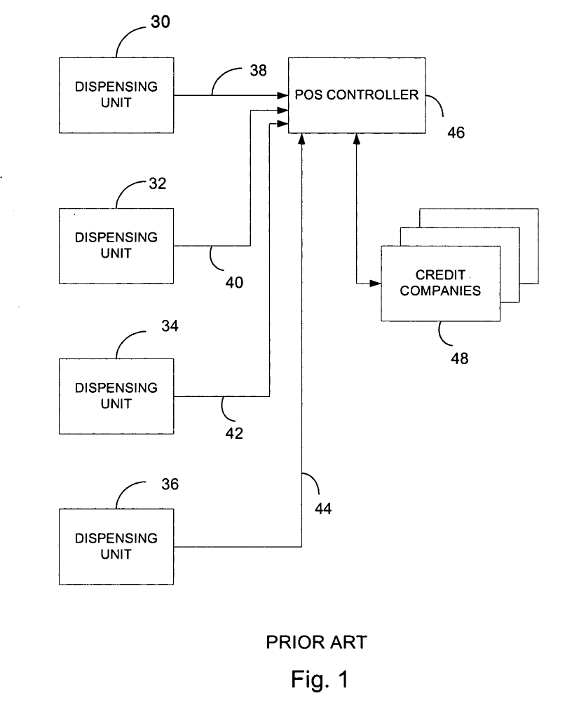

### DETAILED DESCRIPTION OF THE PRESENT INVENTION

In accordance with the present invention several interrelated communications systems are implemented together. Generally these communication systems are employed as a novel fuel dispensing and fund transfer control mechanism. The system of the present invention is intended to efficiently substitute existing POS network employing existing technology, as well as to provide other benefits, to be described below.

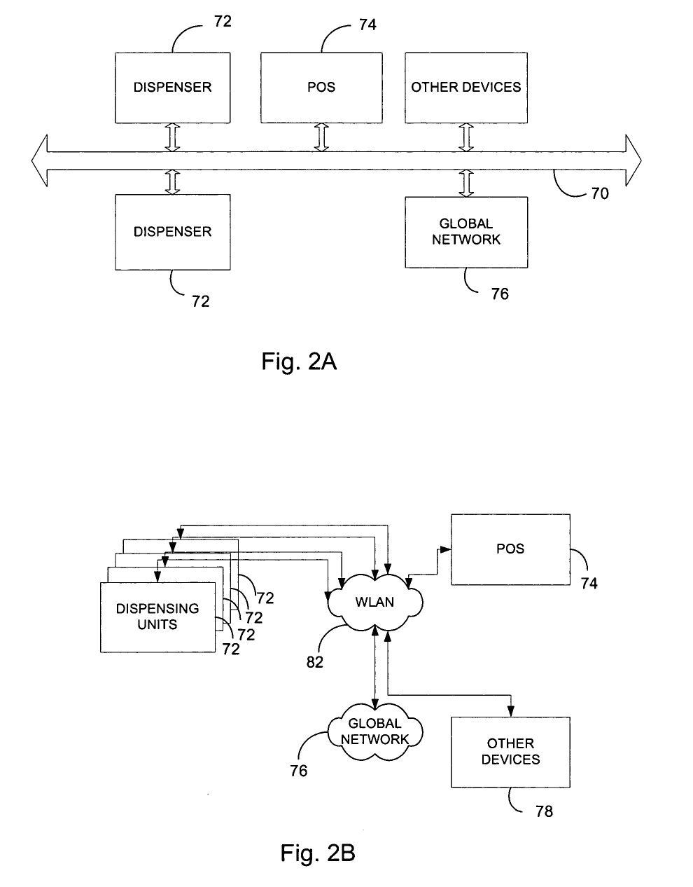

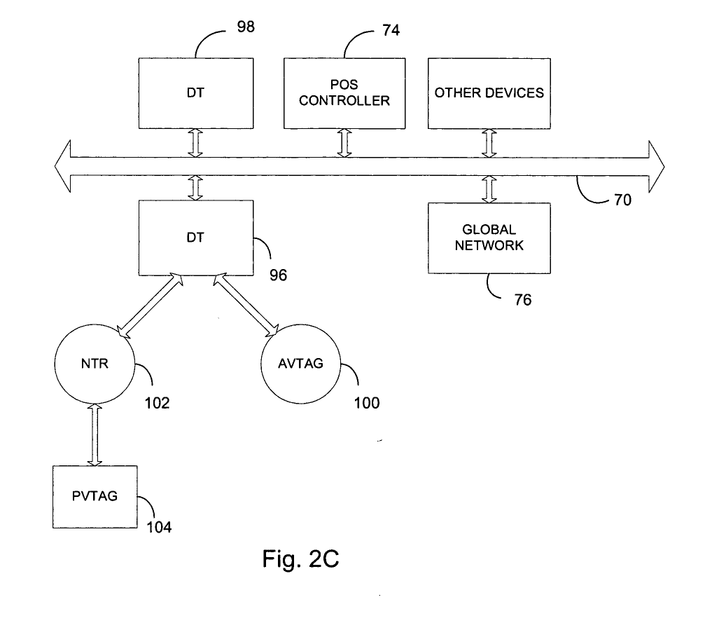

In a preferred embodiment of the invention, at the POS incorporating the system of the invention, three wireless communications networks are integrated, as explained schematically with reference to FIGS. 2A-2C. In FIG. 2A the first subsystem is described as a wireless bus 70 which connects to several types of devices. Fuel dispensing units 72, POS controller 74, global network 76 are a few types of devices connected to the wireless bus 70. In FIG. 2B, the same system is described as a wireless LAN (WLAN) 82 to which are linked dispensing units 72 POS controller 74, and global network 76 and other devices 78.

A fuel dispensers in the POS is directly associated with at least one transceiver, hereinafter referred to as a dispenser unit (DU). The DU communicate with two types of transponders. An active transponder, or an active vehicle tag (AVTAG), and with a nozzle transceiver (NTR) which is also an active tag. The entire set of intercommoning nodes is described schematically in FIG. 2C. DU 96 uses the WLAN 70 to communicate with DU 98 as well as with the POS controller 74. DU 96 communicates with further two nodes, one associated with a vehicle, AVTAG 100, and the other associated with dispensing nozzle, hereinafter referred to as the nozzle transceiver NTR 102. The NTR 104 communicates also with another transponder, typically a passive tag, associated with a vehicle, referred to hereinafter as PVTAG (passive vehicle tag).

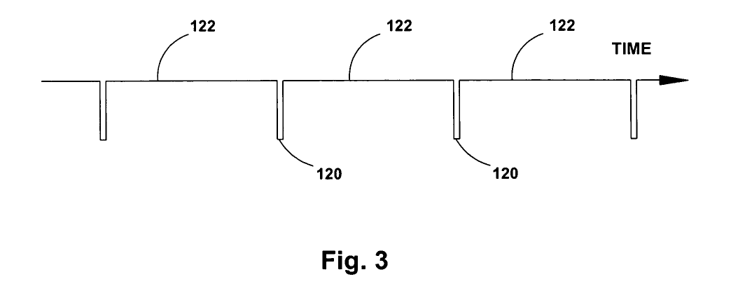

Functionally, the AVTAG pulsates in time as described in FIG. 3 to which reference is now made, sending out signals 120 at intervals 122. Typically, each signal 120 lasts a very short period of time with respect to the interval 122. A typical example is 10 milli-seconds (ms) as compared to 2 second intervals. The reason for the short duration of signal transmission is the need for conservation of energy of the AVTAG. The AVTAG is typically a small object such that can be attached to the key holder of the vehicle, but be moved about also independently for reasons which will be described later on. The signal is intercepted by a DU when the AVTAG reaches a certain range from the forecourt as the POS. Thus, a POS automatically becomes informed of a vehicle of a subscriber when the vehicle travels to an effective distance from a fuel dispenser harboring a DU. If the vehicle lingers int eh effective distance beyond a predefined time period, the AVTAG logs on to POS network. Explained with reference to FIG. 3, the logging-on comes about as a DU of the POS counts at least n (a predetermined number) pulses. This way, a by-by passing subscriber vehicle, spending no substantial amount of time in the POS is not logged-on to the system.

Typically, a subscriber to the fuel dispensing company (FDC) is admitted to the POS services after the subscription has been validated by POS controller using the company's database. Following admittance, the subscriber can proceed to refuelling. To explain the following procedure, reference is again made to FIG. 2C. AVTAG 100 has communicated through DU 96 which is typically associated with a specific fuel dispenser. If however, the subscriber wishes to stop at a different dispenser, or the communications with DU 96 becomes blocked, a communication can continue with another DU, such as DU 98. The DUs themselves inter-communicate through WLAN 70. The POS controller 70 may have, in some embodiments of the invention, access to a database of the subscribers which references the needs of the subscriber and communicates further with the subscriber as will be described later on. Once the subscriber's request to admittance has been validated, the nozzle picked up by the fuelling person, which may be the subscriber him/her self, activates a NTR 102 such as by activating a tilting switch. The preferred location of the NTR is on the refuelling nozzle, which implies that typically the NTR has to have an independent supply of electric power. The NTR is a consumer of power, required for the energizing of its active components, communicating with two wireless communication nodes. One such node type is at least one of the DUs of the POS and the other type is a PVTAG on the vehicle. Typically, the PVTAG is a passive transponder, such as an RFID (radio frequency identification) tag, activated by the NTR which also reads the information stored on the PVTAG. Activation by a tilting switch is one measure of limiting energy waste by the NTR. Example for a suitable RF passive tag is the HITAG line of readers and transponders, working in the 125 KHz frequency, manufactured by Philips Semiconductors (Eindhoven, Holland)

The inclusion of the PVTAG in the loop of authorizing sale of fuel to the subscriber is a theft prevention measure. The two transponders, the AVTAG and the PVTAG of the subscriber are registered as a match by the operating company such that as the DU reads the identity indicia of the two transponders, a verification procedure is performed by the POS controller that compares the indicia of subscriber's pair in the database accessed by the POS controller. This verification procedure insures that if a stolen or otherwise unlawfully acquired AVTAG, fuel dispensing will not be made possible without the presence of the matching PVTAG. Moreover, the PVTAG may be continuously interrogated by the NTR, in order to prevent fraudulent fuel acquisition after the refilling has been authorized and pump began operating. Optionally, additional sensor-transceivers are present in the vehicle, such as odometer transceiver.

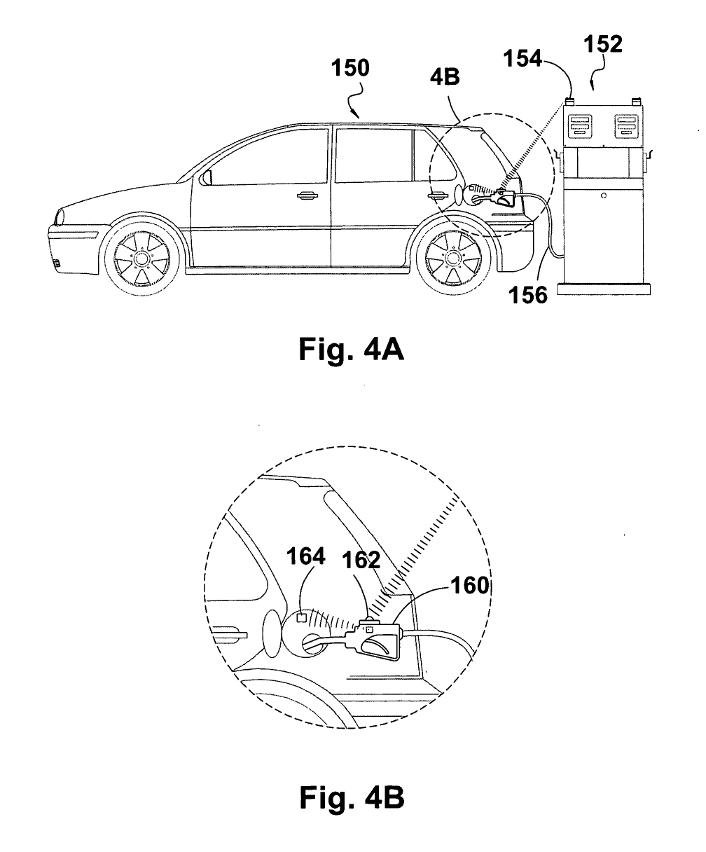

In FIGS. 4A-4B to which reference is now made, the part of the refueling system is shown schematically with communication nodes associated with the vehicle 150. In FIG. 4A, dispenser 152 is shown. Associated with dispenser 152 is DU 154 that communicates with the nozzle of the fuel dispensing hose 156. An enlarged detail of the nozzle and fuel inlet orifice is described schematically in FIG. 4B. Nozzle 160 bears NTR 162 which communicates with passive PVTAG 164 attached to the vehicle. NTR 164 may be unitary or not, but typically the PVTAG is located in the vicinity of the fuel inlet orifice such that the NTR antenna for communicating with the PVTAG is substantially forward-staring, whereas the communication of the NTR with its associated DU does not have a fixed viewing angle in space. Moreover, the NTR is in some embodiments communicative with DUs of other dispensers in the same POS. In some embodiments, a single vehicle may have more than one fuelling inlet orifices, in which case the subscriber will require a respective number of PVTAGs.

As mentioned above, a POS communication system incorporates in accordance with a preferred embodiment of the present invention, three communication subsystems: A first communications subsystem carries out the DU communications tasks, between the various DUs and between the DUs and the POS controller. A second communications subsystem, which is communicable with the first subsystem, handles the DU to nozzle communications tasks and the DU to AVTAG communications tasks. A third subsystem, communicable with the second subsystem, includes s a passive tag reader for reading vehicles' passive tags generally known as RFID (RF identification) systems.

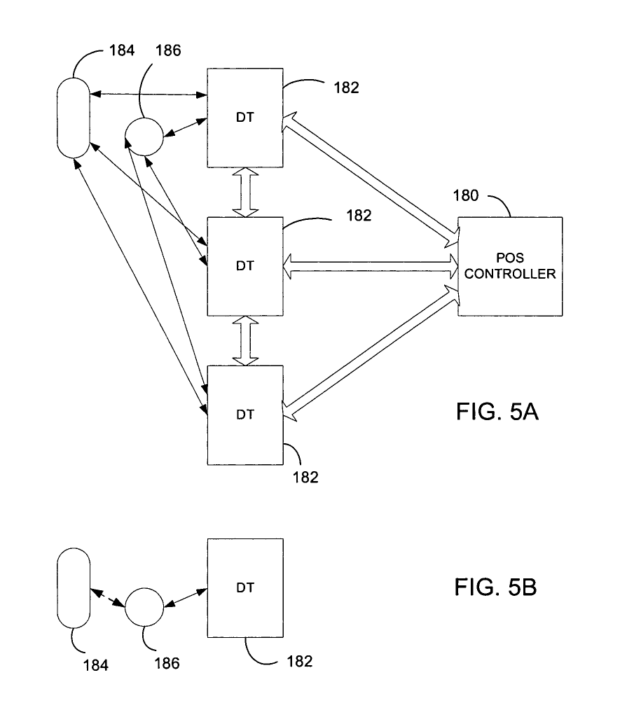

In a preferred embodiment of the invention, the first communications subsystem is a wireless LAN (WLAN), such that various associated end-points in the POS can communicate thereby. The connection topology of the communications system of the invention is described schematically in FIGS. 5A-B to which reference is now made. In FIG. 5A The POS controller 180 is connected by way of the WLAN subsystem to DUs 182. By way of example only three DUs are drawn but the number may vary. All the DUs are connected among themselves by way of the same WLAN. In a second communication subsystem, a vehicle 184 communicates with a DU (any one of them) and any one of the DUs communicates with the NTR 186. In FIG. 5B, a part of the communications system is shown, in which NTR 186, associated with a nozzle, employs a third communications subsystem, which is the RFID connection with the vehicle 184.

Each subsystem of the communications system of the invention is to provide service in view of the following parameters: range (distance) between the end points, power conservation requirements, number of end points, transmission rates, and security requirement. The first subsystem must connect between all the DUs, typically all the DUs and the POS controller, and between an estimated maximal number of vehicles. In addition, this subsystem enables connection of additional end point in the POS such as shops and services, and connections to global networks and or to other external communication end point. Suitable technologies are for example, the WLAN complying with IEEE standard 802.11 (wireless networking) or 802.16 (wireless metropolitan area networks). The first communication subsystem must take over the entire existing wired POS infrastructure such that the functionalities of the wired communications between the dispensers and the POS controller are maintained without restrictions. Moreover, the takeover by the WLAN of a POS following its upgrading from a wired control infrastructure to the system of the invention, is to leave the pre-existing functions, i.e. control over the function of the fuel dispensers, their interaction with the POS controller and the payment transactions, intact.

The second communication subsystem does not take over existing communication facilities in a functional POS. The functions of this system are concerned with communicating the DUs with the AVTAGs, and communicating the DUs with the nozzle transponders. A suitable communications standard for this subsystem is a LR-WPAN (low rate wireless personal area network) such as 802.15.4 which is considerably less demanding with respect to energy consumption and data rate than WLAN standards. Since the DU typically participates in both the first and second communications subsystems, they must employ an appropriate gateway to maintain an interaction between the two subsystems. As indicated above, an additional transponder is employed in some embodiments of the invention, which is connected to the odometer of the vehicle such that information relating to the distances that the vehicle has traveled is passed on to the POS controller, at the instance of refueling. The information derived from the relationships between the odometer reading and fuel consumption is potentially valuable. For example, a vehicle fleet manager can in real time surveillance of the fuel consumption detect potential theft using such information.

The third communications subsystem, relates to a passive component containing information affixed to the vehicle, typically an RFID tag. The information stored on the tag relates to the vehicle's identity but possibly to considerable number of other issues, such as fuel type, maximum fill allowable, and agreement termination date. Preferably, to avoid identity theft, the tag is destructible upon tampering. The nozzle associated NTR is an RFID reader, but it also employs a transceiver to communicate with the DUs. The NTR employs a gateway to facilitate data transport between the first and the second communication subsystems.

The AVTAG and the NTR constitute both communications network end-points. The AVTAG is a small transceiver carried by the subscriber in person and can be transferred from a one vehicle to another one, if the subscriber wishes to do so. To allow refueling, the RFID tags in each of the subscriber's vehicles must be pre-registered as matching the AVTAG by the operator. The AVTAG may be used by the subscriber without association with a vehicle, for example, in case the subscriber uses a POS for purchasing goods and services other than fuel. To ensure a reasonable time between battery change or reload, the AVTAG is to employ appropriate transmission and processing methods. The NTR is another communication network end-point which is self supplied with respect to electrical energy and the various aspects of its function should take into account this limitation.

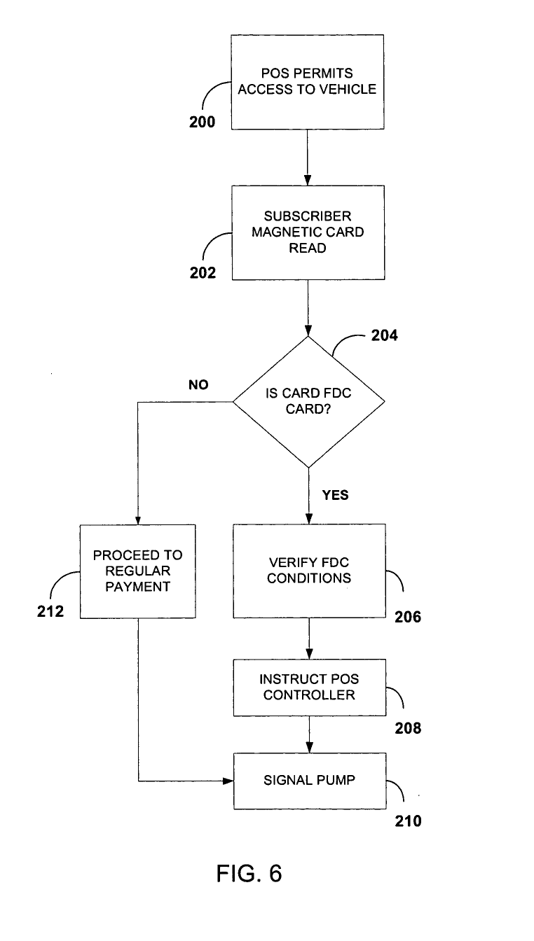

In a typical fuel POS operating today, the use of credit or debit card is facilitated in addition to cash payment. A magnetic card reader at the dispenser or in association with the dispenser reads the customer's card and the pump is signaled to dispense fuel as the POS controller sends a permission in response to the filling request. In case of a credit transaction, the POS controller uses a confirmation by the credit provider weather it is a bank or the fuel company to confirm the transaction. In another aspect of the present invention, a bank is not involved online in a credit transaction. Rather, a subscriber to the FDC using an FDC payment card, after having been admitted to the communications network, while sending a request for credit transaction from the dispenser, is being intercepted by the FDC's operator's system (of which an interface to is installed in the POS controller's end-point). Confirmation is given by the FDC's operator's clearing facility, which signals the POS controller to facilitate refuelling. These aspects of the payment are explained more clearly with reference to FIG. 6 In step 200 the POS controller permits access to the vehicle AVTAG after having verified the AVTAG and the match between the AVTAG and the PVTAG. In step 202 the subscriber feeds the data of a magnetic card into the magnetic card reader associated with the dispenser. At the POS controller, an interface of the FDC checks the data of the magnetic card at step 204. If it is a FDC card, the FDC verifies the card data, at step 206 and if terms are met, it instructs the POS controller to proceed as usual at step 208, in which case the pump is signaled at step 110. In this course, the FDC performs the clearing without the intervention of the bank while the POS controller behaves as if the transaction is a regular transaction employing a credit provider such as a bank. If in step 204 the card is not identified as a FDC card, the POS controller proceeds to regular transaction in step 212, and if the credit provider such as a bank issues a permit in the case of a credit transaction, the pump is signaled at step 210.

In another aspect of the invention, a further security measure is provided to confirm the admissibility of a magnetic card used for payment at the POS. Accordingly, an asymmetric public key cryptographic procedure is applied as follows. The identification number associated with the magnetic card, once read by the magnetic card reader is sent to the POS controller, on the other hand, an encrypted message from the AVTAG is sent to the POS controller. This encrypted message is encrypted by private key. The number obtained from the card is the complementary public key which can decrypt the message sent from the AVTAG. The decryption can be performed by the POS controller or by the clearing facility.

1. A pint of sale (POS) for dispensing fuel to vehicles, employing a wireless communications system for managing said dispensing and payment transactions, comprising:
a first communications subsystems connecting the dispensing units (DUs) among themselves and at least one such DU to the POS controller;
a second communications subsystem for communicating said DUs with at least one active vehicle tag (AVTAG) and for communicating said DUs with at least one nozzle transponder (NTRs) and wherein said second subsystem is communicable with said first subsystem;
a third communications subsystem for activating a passive vehicle tag (PVTAG) and collecting data therefrom and wherein said third subsystem is communicable with said second subsystem.

2. A point of sale (POS) for dispensing fuel to vehicles, employing a wireless communications system as in claim 1 and wherein said PVTAG is a RFID tag and wherein said NTR comprises a RFID reader.

3. A point of sale (POS) for dispensing fuel to vehicles, employing a wireless communications system as in claim 1 and wherein said first communications system is a wireless LAN.

4. A point of sale (POS) for dispensing fuel to vehicles, employing a wireless communications system as in claim 1 and wherein said second communications subsystem is less demanding with respect to energy consumption as compared to wireless LAN.

5. A point of sale (POS) for dispensing fuel to vehicles, employing a wireless communications system as in claim 4 and wherein said second communications subsystem complies with the low rate wireless personal area network.

6. A point of sale (POS) for dispensing fuel to vehicles, employing a wireless communications system as in claim 1 and wherein an odometer transceiver sends travel information through said wireless communication system.

7. A method for managing a fuel dispensing transaction, wherein a subscriber to a fuel dispensing company (FDC) is being allowed to refuel, comprising:
approaching said POS;
logging on to the communications network of said POS;
admitting said subscriber vehicle to its services after verifying match between two subscriber associated identifying stored data;
FDC confirms credit status of said subscriber, passing confirmation to POS controller, and
POS controller signals pump.

8. A method for managing a fuel dispensing transaction, as in claim 7, wherein said POS controller reports credit requests to a bank or to an FDC.

9. A method for admitting a subscriber to the services of a point of sale (POS), wherein said POS controller validates the request for admittance by one active vehicle tag (AVTAG) logging on to a wireless communications network of said POS.

10. A method for managing a fuel dispensing transactions, as in claim 7, wherein a double key decryption procedure is used for confirming the admissibility of a magnetic card, and wherein the public key for said decryption is derived from the card.
